(19) United States
(12) Patent Application Publication
(10) Pub. No.: US 2021/0230976 A1
(43) Pub. Date: Jul. 29, 2021

(54) SYSTEMS AND METHODS FOR THERMAL MANAGEMENT OF SUBSEA CONDUITS USING AN INTERCONNECTING CONDUIT HAVING A CONTROLLABLE ANNULAR SECTION

(71) Applicant: Chevron U.S.A. Inc., San Ramon, CA (US)

(72) Inventors: Antonio C.F. CRITSINELIS, Kingwood, TX (US); Sid MEBARKIA, Sugar Land, TX (US); Michelle A. WISE, Berkeley, CA (US); Yesudas J. MANIMALA, Katy, TX (US); William C. HUGHES, Houston, TX (US); Steven W. COCHRAN, Houston, TX (US); Edgar URIBE, Houston, TX (US); Jason D. GARCIA, Bellaire, TX (US)

(73) Assignee: Chevron U.S.A. Inc., San Ramon, CA (US)

(21) Appl. No.: 16/774,723

(22) Filed: Jan. 28, 2020

(51) Int. Cl. E21B 36/00; E21B 43/01; E21B 47/00; E21B 47/06; E21B 47/10; G08B 21/18

(52) U.S. Cl. CPC E21B 36/001; E21B 43/01; G08B 21/18; E21B 47/065; E21B 47/10; E21B 47/0001

(57) ABSTRACT

Disclosed are systems and methods for thermal management of subsea jumpers that provide the ability to cool and/or retain heat in production fluids within the jumpers. The jumpers are provided with an annular pipe section surrounding the jumper circumferentially. The flow of a liquid cooling medium into an inlet and out an outlet of the annular pipe section can be controlled to provide cooling or heat retention as needed. A control system can be used to generate an alarm based on fluid temperature and/or fluid flow rate within the jumper indicating the need to adjust the flow of the cooling medium to manage the temperature of fluids within the jumper. Changes may be needed particularly depending on the phase of production, e.g., early life, normal operation, shut down and late life operation.

### FIELD

This disclosure relates generally to subsea oil and gas production facilities, and particularly to interconnecting conduits extending between subsea components. The disclosure further relates to thermal management of such interconnecting conduits.

### BACKGROUND

The production of hydrocarbons from offshore oil and gas reservoirs requires the transportation of production fluids from the reservoirs to subsea facilities for processing. Three phases, i.e., oil, gas and water, may be included in the production fluids. Subsea developments increasingly must accommodate high temperature production fluids that need to be safely transported to the production facility. The high temperature of the production fluids can have several undesirable effects. Special grade subsea and pipeline materials, extensive qualifications of insulation coating and expensive modifications topsides may be required to handle the high temperature of the product. For instance, water cooled heat exchangers may be used topsides on an offshore platform to reduce the temperature of production fluids, e.g., from around 400° F. to a temperature below 250° F., involving weight, space, cost, etc. In the subsea facility, the high temperature of the product may undesirably result in the occurrence of upheaval buckling, lateral buckling and pipeline walking in flowlines carrying the product. The temperature may also undesirably accelerate corrosion and therefore reduce the life of the flowlines. Attempts have been made at providing a subsea cooling system for use with gas production. No established oil or three phase subsea cooling system is available in the industry.

There exists a need for cost-effective subsea cooling systems and methods that can be applied to subsea flowlines or interconnecting conduits such as jumpers that carry three-phase production fluids to enable the development of high temperature subsea fields without the disadvantages of known systems.

### SUMMARY

In general, in one aspect, the disclosure relates to a system for thermal management of a subsea conduit that carries oil and/or gas produced from a subsea well in a subsea production facility located on a seabed. The system includes an interconnecting conduit for carrying production fluids having a length, an outer diameter and two ends for connecting to subsea components. An annular pipe section having two ends, an annular pipe section length, and an annular pipe section outer diameter greater than the interconnecting conduit outer diameter surrounds at least a portion of the interconnecting conduit. A fluid inlet at one of the two ends of the annular pipe section can receive liquid cooling medium into the annular pipe section when the fluid inlet is opened. A fluid outlet at the other of the two ends of the annular pipe section can discharge liquid from the annular pipe section when the fluid outlet is opened. A control system can be set to open or close the fluid inlet and open or close the fluid outlet based on a predetermined fluid temperature and/or flow rate.

In another aspect, the disclosure can generally relate to a method for thermal management of the subsea conduit in the subsea production facility. The method includes transmitting fluids comprising oil and/or gas produced from the subsea well through the interconnecting conduit having the annular pipe section as described above surrounding at least a portion of the interconnecting conduit concentrically. The control system opens and closes the fluid inlet and the fluid outlet when a detected fluid temperature and/or flow rate of the transmitted fluids reach a predetermined fluid temperature and/or flow rate, thereby adjusting an amount of heat transfer between the interconnecting conduit and the annular pipe section.

### BRIEF DESCRIPTION OF THE DRAWINGS

These and other objects, features and advantages of the present invention will become better understood with reference to the following description, appended claims and accompanying drawings. The drawings are not considered limiting of the scope of the appended claims. Reference numerals designate like or corresponding, but not necessarily identical, elements. The drawings illustrate only example embodiments. The elements and features shown in the drawings are not necessarily to scale, emphasis instead being placed upon clearly illustrating the principles of the example embodiments. Additionally, certain dimensions or positionings may be exaggerated to help visually convey such principles.

FIG. 1 shows an example embodiment of a subsea jumper according to the prior art.

FIG. 2 shows an example embodiment of a self-draining interconnecting conduit.

FIG. 3 shows another example embodiment of a self-draining interconnecting conduit.

FIG. 4 shows yet another example embodiment of a self-draining interconnecting conduit.

FIG. 5 shows an example embodiment of a phase change thermostat for use with a self-draining interconnecting conduit.

FIG. 6 shows another example embodiment of a phase change thermostat for use with a self-draining interconnecting conduit.

### DETAILED DESCRIPTION

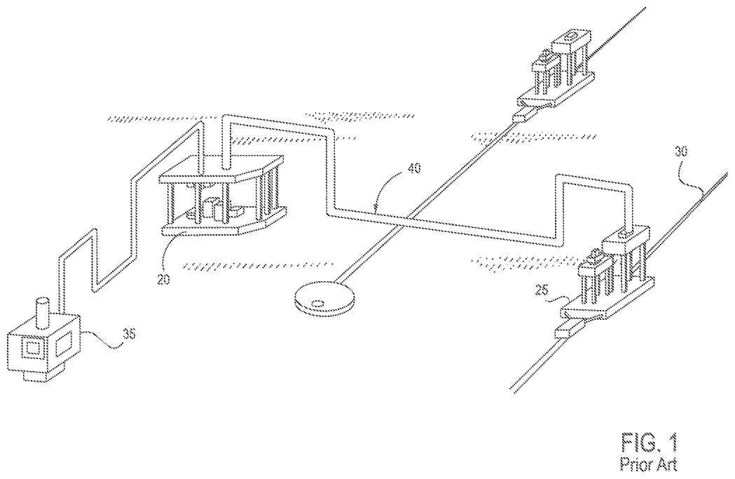

Referring to FIG. 1, a prior art subsea production facility is shown. A subsea pipeline 30 carries oil and/or gas produced from a subsea well 35 in the facility located on the seabed. A jumper 40 is connected to a first subsea component 20 (in this case, a manifold) and a second subsea component 25 (in this case, a pipeline end termination (PLET)). The subsea jumper 40 connects two different structures such as manifold and PLET to allow product flow to or from a subsea pipeline 30. The subsea pipeline 30 is connected to the pipeline end termination. The subsea jumper 40 typically consists of interconnected pipes, connectors, bends and insulation coating. The insulation (not shown) can ensure the product remains flowing above a certain temperature to avoid formation of waxes or hydrates that risk plugging the jumper pipe and stopping production. During shut down when production is stopped, the insulation is used to allow a minimum safe cool down time typically in the range of 12 to 16 hours to avoid formation of waxes of hydrates. As shown, the jumper 40 is shaped with a general M-shape to allow for safe thermal expansion as the temperature of the produced fluids increase through the jumper 40. This helps prevent thermal fatigue of the jumper 40.

Systems and methods are described herein for thermal management of subsea conduit for carrying oil and/or gas produced from a subsea well in a subsea production facility in ways not possible using prior art methods. The system includes an interconnecting conduit circuit 2, also referred to herein as a jumper circuit 2, for carrying production fluids between subsea components (e.g., manifolds, wellheads, pipeline end terminations, and other equipment residing on the seabed). The conduit or jumper can be any suitable device as known for permitting the flow of produced fluids therethrough, e.g., a spool, a jumper or a pipe. The jumper has two ends for connecting to subsea components, such as but not limited to wellheads, manifolds, pipeline end terminations (PLETs), and the like. In various embodiments, the jumper is self-draining and can have variable insulation to manage operation when cooling is needed as well as shutdown or late stage when heat retention is needed. The system advantageously provides the ability to adjust between cooling mode during normal operation and heat retention mode during shut down or late life operation.

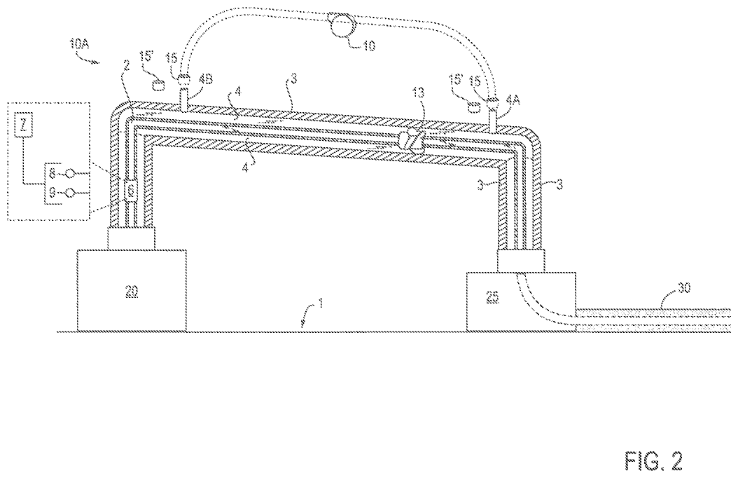

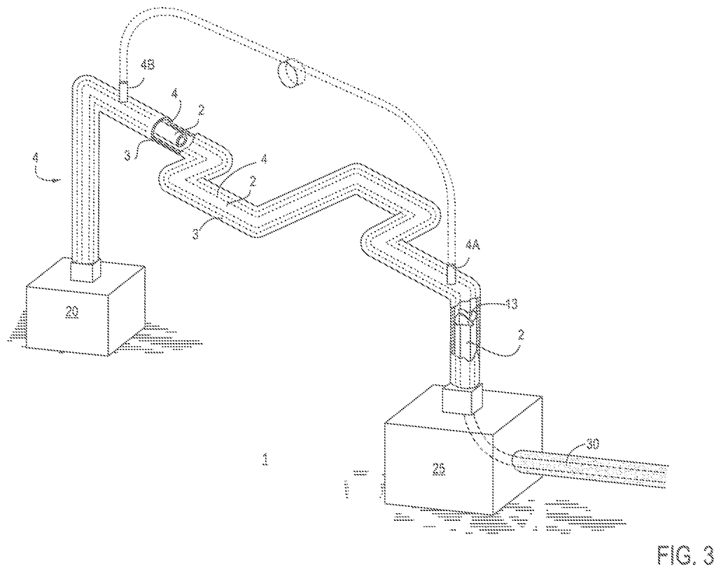

In one embodiment, referring to FIG. 2, a system is shown for thermal management of a subsea jumper 2 for carrying oil and/or gas produced from a subsea well in a subsea production facility located on a seabed 1 in which the jumper 2 has two ends for connecting to subsea components (20 and 25). The jumper 2 is surrounded by an annular pipe section 4 over at least a portion of the length of the jumper. The annular pipe section 4 has two ends, a length, and an outer diameter greater than the outer diameter of the jumper 2. The annular pipe section 4 has a fluid inlet 4A at one end thereof that can receive liquid cooling medium when the fluid inlet is opened, thereby enabling cooling of the jumper 2. In one embodiment, the liquid cooling medium is seawater and the fluid inlet 4A is connected to the surrounding seawater. The annular pipe section 4 also has a fluid outlet 4B at the other end thereof that can discharge liquid when the fluid outlet is opened. The fluid inlet 4A and outlet 4B can be closed with plugs 15. In one embodiment, the jumper 2 and the annular pipe section 4 include segments changing in direction, e.g., in a zig-zagging configuration, and sloping downward such that flow of fluid in the jumper is assisted by gravity thereby ensuring self-draining of the fluid independent from fluid pressure in the jumper 2. An example of such a configuration is shown in FIG. 3 where jumper segments change direction and slope downward. In one embodiment, the jumper 2 (and surrounding annular pipe section 4) is positioned at an angle greater than 0 degrees and less than 90 degrees such that the jumper 2 is sloping with respect to the seabed 1. Other configurations are possible that also ensure self-draining.

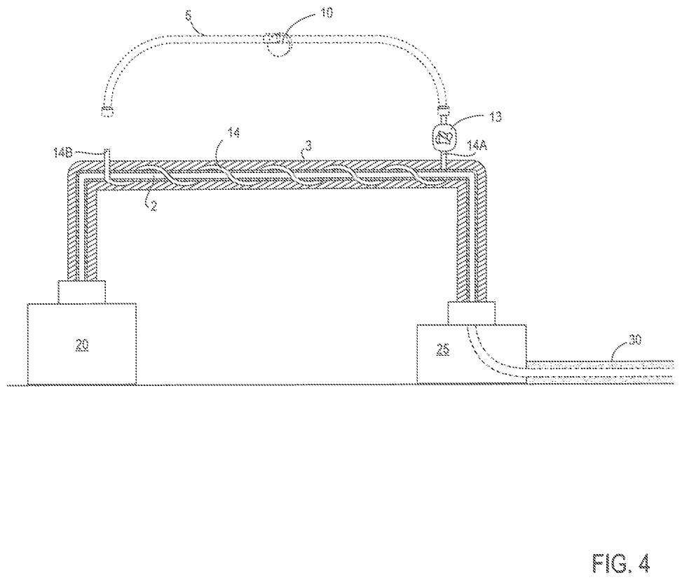

In one embodiment, referring to FIG. 4, the annular pipe section 4 surrounding the jumper 2 can be a section of pipe having a diameter less than the outer diameter of the jumper 2 wrapped helically around at least the portion of the jumper 2, also referred to as the helical pipe section 14. The helical pipe section 14 can have an inlet 14A and an outlet 14B.

In all embodiments, insulation 3 can optionally surround the annular pipe section 4.

Returning to FIG. 2, in one embodiment, the fluid inlet 4A and the fluid outlet 4B are in fluid communication with each other and connected to a parallel jumper 5 surrounded by seawater such that the annular pipe section 4 and the parallel jumper 5 form a closed loop circuit. A pump 10 can be used to circulate the liquid cooling medium in the closed loop circuit, thereby enhancing heat transfer between the jumper 5 and the annular pipe section 4. The pump 10 can be located in a subsea location or at a surface location.

In one embodiment, a temperature sensor 8 and/or a flow rate sensor 9 are used to detect a fluid temperature and/or flow rate of the fluids transmitted in the jumper 2. In one embodiment, the system further utilizes a control system 6 having a processor 7 configured to receive temperature and/or flow rate information on fluid flowing through the jumper 2 from the temperature sensor 8 and/or the flow rate sensor 9, respectively. The fluid temperature and/or flow rate data is transmitted from the temperature sensor and/or the flow rate sensor to the control system by a flying lead or an umbilical 12. The control system 6 can be configured to open and close the fluid inlet 4A and the fluid outlet 4B when the detected fluid temperature and/or flow rate reach a predetermined fluid temperature and/or flow rate. The control system 6 can thereby adjust an amount of heat transfer between the jumper 2 and the annular pipe section 4 having the liquid cooling medium therein.

The processor 7 can be configured to determine whether to activate an alarm indicating the need to open or close the fluid inlet 4A and the fluid outlet 4B based on the predetermined fluid temperature and/or flow rate as detected in the jumper 2 by the temperature sensor 8 and/or a flow rate sensor 9, respectively.

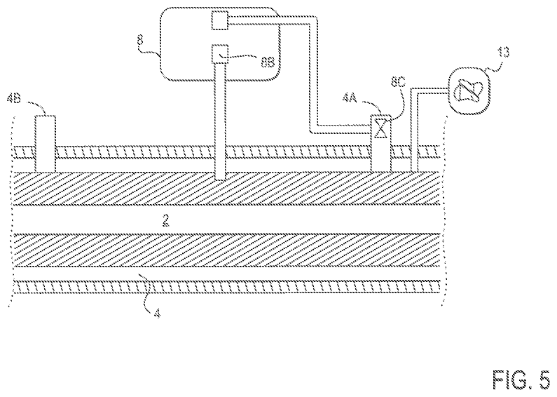

In one embodiment, referring to FIG. 5, the temperature sensor 8 can be a phase change thermostat 8. In this embodiment, the phase change thermostat 8 can be used for controlling the fluid inlet 4A. The phase change thermostat 8 can be connected to the jumper 2. Phase change material 8A in the phase change thermostat has a predetermined threshold temperature substantially equivalent to the predetermined fluid temperature of the control system 6. A piston 8B connected to the phase change material 8A and the fluid inlet 4A automatically causes a control valve 8C at the fluid inlet 4A to open when the volume of the phase change material 8A in the thermostat 8 increases (above the predetermined threshold temperature). When the fluid inlet 4A is thus opened, liquid cooling medium cools the fluid in the jumper 2.

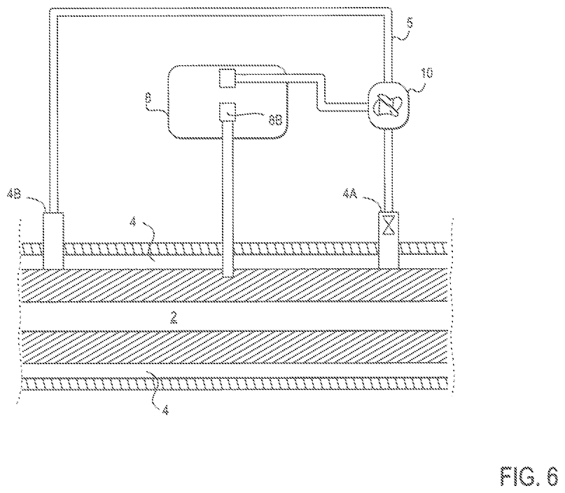

In one embodiment, referring to FIG. 6, the phase change thermostat 8 can be connected to the pump 10. In this scenario, the phase change of the phase change thermostat 8 can be used to automatically cause the pump 10 to increase the flow rate of liquid cooling medium and in turn cool the fluid in the jumper 2. In some embodiments, the phase change thermostat 8 is encased in a pressurized chamber to prevent hydrostatic collapse of the phase change thermostat 8.

In one embodiment, referring to FIGS. 2 and 3, a thermal to electrical fan 13 can be mounted proximate the fluid inlet 4A to drive flow of the liquid cooling medium in the annular pipe section 4. The thermal to electrical fan 13 can be powered by heat energy from fluid flowing in the jumper 2. The thermal to electrical fan 13 is not needed when the jumper 5 is used to create a closed loop.

In one embodiment, the fluid inlet 4A and the fluid outlet 4B are opened and closed by an ROV (not shown). In one embodiment, the control system 6 is configured to open and close the fluid inlet 4A and the fluid outlet 4B automatically as needed as determined by the processor 7.

It should be noted that only the components relevant to the disclosure are shown in the figures, and that many other components normally part of a subsea oil and gas field are not shown for simplicity.

For the purposes of this specification and appended claims, unless otherwise indicated, all numbers expressing quantities, percentages or proportions, and other numerical values used in the specification and claims are to be understood as being modified in all instances by the term “about.” Accordingly, unless indicated to the contrary, the numerical parameters set forth in the following specification and attached claims are approximations that can vary depending upon the desired properties sought to be obtained by the present invention. It is noted that, as used in this specification and the appended claims, the singular forms “a,” “an,” and “the,” include plural references unless expressly and unequivocally limited to one referent.

Unless otherwise specified, the recitation of a genus of elements, materials or other components, from which an individual component or mixture of components can be selected, is intended to include all possible sub-generic combinations of the listed components and mixtures thereof. Also, “comprise,” “include” and its variants, are intended to be non-limiting, such that recitation of items in a list is not to the exclusion of other like items that may also be useful in the materials, compositions, methods and systems of this invention.

What is claimed is:

1. A system for thermal management of a subsea conduit that carries oil and/or gas produced from a subsea well in a subsea production facility located on a seabed, comprising:
a. a jumper for carrying production fluids having a jumper length, a jumper outer diameter and two ends for connecting to subsea components; and
b. an annular pipe section surrounding at least a portion of the jumper wherein the annular pipe section has two ends, an annular pipe section length, and an annular pipe section outer diameter greater than the jumper outer diameter;
c. a fluid inlet at one of the two ends of the annular pipe section that can receive liquid cooling medium into the annular pipe section when the fluid inlet is opened;
d. a fluid outlet at the other of the two ends of the annular pipe section that can discharge liquid from the annular pipe section when the fluid outlet is opened; and
e. a control system capable of being set to open or close the fluid inlet and open or close the fluid outlet based on a predetermined fluid temperature and/or flow rate.

2. The system of claim 1 wherein the jumper is positioned at an angle greater than 0 degrees and less than 90 degrees such that the jumper is sloping with respect to the seabed.

3. The system of claim 1 wherein the fluid inlet is connected to seawater such that the liquid cooling medium is seawater.

4. The system of claim 1 wherein the fluid inlet and the fluid outlet are in fluid communication with each other and connected to a parallel jumper surrounded by seawater such that the annular pipe section and the parallel jumper form a closed loop circuit, further comprising a pump for circulating the liquid cooling medium in the closed loop circuit, thereby enhancing heat transfer between the jumper and the annular pipe section.

5. The system of claim 4 wherein the pump is located in a subsea location or at a surface location.

6. The system of claim 1 wherein the control system receives fluid temperature and/or flow rate data from a temperature sensor for monitoring an internal fluid temperature and/or a flow rate sensor for monitoring an internal fluid flow rate of fluid in the jumper; wherein when the predetermined fluid temperature and/or flow rate is reached, the control system will activate an alarm indicating the need to adjust the fluid inlet and the fluid outlet.

7. The system of claim 1 wherein the control system comprises a phase change thermostat for controlling the fluid inlet wherein the phase change thermostat is connected to the jumper and contains a phase change material that has a predetermined threshold temperature substantially equivalent to the predetermined fluid temperature of the control system; further comprising a piston connected to the phase change thermostat and the fluid inlet; wherein above the predetermined threshold temperature, a volume of the phase change material reversibly increases, thereby automatically causing the piston to open the fluid inlet to increase liquid cooling medium flow to in turn cool fluid in the jumper.

8. The system of claim 4 further comprising a phase change thermostat connected to the pump for controlling the pump wherein the phase change thermostat contains a phase change material that has a predetermined threshold temperature substantially equivalent to the predetermined fluid temperature of the control system; further comprising a piston connected to the phase change thermostat and the pump; wherein above the predetermined threshold temperature, a volume of the phase change material reversibly increases, thereby automatically causing the pump to increase a flow rate of liquid cooling medium flow to in turn cool fluid in the jumper.

9. The system of claim 7 or 8 wherein the phase change thermostat is encased in a pressurized chamber to prevent hydrostatic collapse of the phase change thermostat.

10. The system of claim 6 wherein the fluid temperature and/or flow rate data is transmitted from the temperature sensor and/or the flow rate sensor to the control system by a flying lead or an umbilical.

11. The system of claim 6 wherein when the predetermined fluid temperature and/or flow rate is reached, the control system will further automatically adjust the fluid inlet and the fluid outlet.

12. The system of claim 3 further comprising a thermal to electrical fan mounted proximate the fluid inlet to drive flow of the liquid cooling medium in the annular pipe section wherein the thermal to electrical fan is powered by heat energy from fluid flowing in the jumper.

13. The system of claim 1 wherein the annular pipe section surrounding at least the portion of the jumper comprises a helical pipe section wrapped around at least the portion of the jumper helically wherein the helical pipe section has two ends, a helical pipe section length, and a helical pipe section diameter less than the jumper outer diameter.

14. The system of claim 1 further comprising insulation surrounding the annular pipe section.

15. The system of claim 1 wherein the jumper includes jumper segments changing in direction such that flow of fluid in the jumper is assisted by gravity in a downward direction thereby ensuring self-draining of the fluid independent from fluid pressure in the jumper.

16. A method for thermal management of a subsea conduit that carries oil and/or gas produced from a subsea well in a subsea production facility located on a seabed, comprising:
a. transmitting fluids comprising oil and/or gas produced from the subsea well through a jumper having a jumper length, a jumper outer diameter, two ends for connecting to subsea components, and an annular pipe section surrounding at least a portion of the jumper; wherein the annular pipe section comprises:
i. two ends;
ii. an annular pipe section length;
iii. an annular pipe section diameter greater than the jumper outer diameter;
iv. a fluid inlet at one of the two ends of the annular pipe section that can receive liquid cooling medium into the annular pipe section when the fluid inlet is opened; and
v. a fluid outlet at the other of the two ends of the annular pipe section that can discharge liquid from the annular pipe section when the fluid outlet is opened;
b. detecting a fluid temperature and/or flow rate of the transmitted fluids; and
c. opening and closing the fluid inlet and the fluid outlet when the detected fluid temperature and/or flow rate reach a predetermined fluid temperature and/or flow rate thereby adjusting an amount of heat transfer between the jumper and the annular pipe section.

17. The method of claim 16 wherein the jumper is positioned at an angle greater than 0 degrees and less than 90 degrees such that the jumper is sloping with respect to the seabed

18. The method of claim 16 wherein the fluid inlet is connected to seawater such that the liquid cooling medium is seawater.

19. The method of claim 16 wherein the fluid inlet and the fluid outlet are in fluid communication with each other and connected to a parallel jumper such that the annular pipe section and the parallel jumper form a closed loop circuit, further comprising circulating the liquid cooling medium in the closed loop circuit using a pump, thereby enhancing heat transfer between the jumper and the annular pipe section.

20. The method of claim 19 wherein the pump is located in a subsea location or at a surface location.

21. The method of claim 16 wherein a control system receives the detected fluid temperature and/or flow rate from a temperature sensor for monitoring an internal fluid temperature and/or a flow rate sensor for monitoring an internal fluid flow rate of fluid in the jumper; wherein when the predetermined fluid temperature and/or flow rate is reached, the control system activates an alarm indicating the need to adjust the fluid inlet and the fluid outlet.

22. The method of claim 16 further comprising controlling the fluid inlet using a phase change thermostat connected to the jumper and containing a phase change material having a predetermined threshold temperature substantially equivalent to the predetermined fluid temperature; further comprising operating a piston connected to the phase change thermostat and the fluid inlet such that above the predetermined threshold temperature, a volume of the phase change material reversibly increases, thereby automatically causing the piston to open the fluid inlet to increase liquid cooling medium flow to in turn cool fluid in the jumper.

23. The method of claim 19 further comprising controlling the pump using a phase change thermostat connected to the pump wherein the phase change thermostat contains a phase change material that has a predetermined threshold temperature substantially equivalent to the predetermined fluid temperature; further comprising operating a piston connected to the phase change thermostat and the pump such that above the predetermined threshold temperature, a volume of the phase change material reversibly increases, thereby automatically causing the pump to increase a flow rate of liquid cooling medium flow to in turn cool fluid in the jumper.

24. The method of claim 22 or 23 wherein the phase change thermostat is encased in a pressurized chamber to prevent hydrostatic collapse of the phase change thermostat.

25. The method of claim 21 wherein the fluid temperature and/or flow rate data is transmitted from the temperature sensor and/or the flow rate sensor to the control system by a flying lead or an umbilical.

26. The method of claim 19 wherein when the predetermined fluid temperature and/or flow rate is reached, the fluid inlet and the fluid outlet are automatically adjusted.

27. The method of claim 17 further comprising driving flow of the liquid cooling medium in the annular pipe section using a thermal to electrical fan mounted proximate the fluid inlet wherein the thermal to electrical fan is powered by heat energy from fluid flowing in the jumper.

28. The method of claim 16 wherein the annular pipe section surrounding at least the portion of the jumper comprises a helical pipe section wrapped around at least the portion of the jumper helically wherein the helical pipe section has two ends, a helical pipe section length, and a helical pipe section diameter less than the jumper outer diameter.
